(19) United States
(12) Patent Application Publication
(10) Pub. No.: US 2026/0073388 A1
(43) Pub. Date: Mar. 12, 2026

(54) TimeCurrency Protocol_A_Unified Infrastructure for Time-Based Wealth, Banking, and Global Equity

(71) Applicant: FURONG BEI, SAN GABRIEL, CA (US)

(72) Inventor: FURONG BEI, SAN GABRIEL, CA (US)

(21) Appl. No.: 19/182,490

(22) Filed: Apr. 17, 2025

(51) Int. Cl. G06Q 20/40; G06Q 20/02

(52) U.S. Cl. CPC G06Q 20/401; G06Q 20/023

(57) ABSTRACT

A protocol mints a transferable, time-denominated digital currency unit (TMC) only when three conditions are jointly satisfied: a verified Behavioral Economics Identity (BEI) anchored by a non-transferable Sovereign Behavior Token (SBT); an authenticated behavior record; and a cryptographic time-proof verified under zero-knowledge. A clearing layer executes order intake, matching, netting, settlement instruction, receipt, and reconciliation with ISO 20022 mappings and CBDC or fiat interoperability. Governance includes Universal Basic Time Income, inflation or deflation controls, a TimeDAO, and a selectively transparent audit interface employing verifiable-credential attestations and zero-knowledge summaries.

### CROSS-REFERENCE TO RELATED APPLICATIONS

This application claims priority to, and is a continuation-in-part of, one or more U.S. patent applications filed by the same inventor. The entire contents of each of the foregoing applications are incorporated by reference herein. This comprehensive list is based on a review of the inventor's portfolio and is subject to final confirmation by legal counsel. Related applications include, by way of example: Core Foundational Applications: App. No. 19/227,265: “BEI Human Sovereign Eco Decentralized Behavior_to_Currency Ecosystem”; App. No. 19/224,923: “BEHAVIOR-DRIVEN DECENTRALIZED SOVEREIGN ECOSYSTEM WITH MULTI-TIERED DOMAIN NAME MANAGEMENT, TOKEN MINTING, AND DAO-BASED GOVERNANCE”; App. No. 19/208,621: “Behavioral_Economic_Identity (BEI) Sovereign Civilization Chronometry, Calendar Eras, and Multi-Domain Structural Integration”; App. No. 19/197,979: “BEI_24HWS Global Behavioral Financial Banking System Self_Generating Currency Engine for the Human Sovereign Ecology”; PCT/US25/27656: “BEI×24HWS Sovereign Behavioral Currency Engine and Banking Framework”; Supporting Infrastructure and Technology Applications: U.S. Ser. No. 19/070,527: “System and Method for Comprehensive Asset Tokenization, Dynamic Credit Management, and Automated Financial Transactions Utilizing Blockchain and AI”; U.S. Ser. No. 19/074,326: “Universal Decentralized Banking, Wallet, and Vault System”; U.S. Ser. No. 19/074,352: “AI and Smart Contract-Based Autonomous Banking System”; U.S. Ser. No. 19/094,730: “Your Genesis, 24HWS-Based Multi-System Sovereign Domain Engine for Every Person, Every Domain, Every Time”; App. No. 19/218,272: “Decentralized On-Chain Publishing Platform and BEI Sovereign Semantic Ecosystem”; App. No. 19/198,128: “AI-Driven Dynamic Financial Management System”.

### INCORPORATION BY REFERENCE

Without relying on external materials for enablement, the following standards/specifications are incorporated by reference for interoperability and compliance alignment: ISO 20022 (financial messaging), W3C Decentralized Identifiers (DID) Core, W3C Verifiable Credentials (VC) Data Model, DNSSEC/DANE (secure name-to-endpoint anchoring), and cryptographic standards sufficient for digital signatures and zero-knowledge proofs. Where any incorporated material conflicts with this disclosure, this disclosure governs. Incorporated materials clarify interfaces and do not impose limitations unless expressly recited in the claims.

### TECHNICAL FIELD

The disclosure relates to financial technologies, distributed ledger systems, identity/authentication, and clearing infrastructures. More particularly, it concerns methods, systems, and governance mechanisms for converting verified human time and activity into a transferable, time-denominated digital currency unit, clearing that unit across chains and institutions, and operating the currency under compliance-ready, selectively transparent oversight.

### BACKGROUND

Complementary currencies such as hour-based community scrip lack strong identity assurance, scalable anti-Sybil controls, and interoperable clearing with mainstream finance. First-generation blockchains provide transparent settlement but typically anchor value to compute, stake, or fiat reserves rather than auditable human time. Time-lock smart contracts govern spendability by time conditions yet do not define how time itself is minted into value. Credential systems bind attributes to accounts but do not produce a transferable, clearable time unit with regulator-grade auditability. A protocol is needed that mints value from verified human time under identity and behavior guarantees, provides cross-institution clearing, and exposes compliance-grade audit without compromising individual privacy.

### SUMMARY

A full-stack TimeCurrency Protocol (TCP) is disclosed. TCP atomically binds (a) a verified Behavioral Economics Identity (BEI), (b) authenticated behavior records, and (c) a cryptographic time-proof into a mint condition. Only upon satisfaction of all three does the system mint a transferable time-denominated currency unit (TMC). The BEI is represented by a non-transferable Sovereign Behavior Token (SBT) anchoring identity and permissions; the TMC is freely transferable subject to policy.

A clearing and settlement layer defines message formats and steps-order intake, matching, netting, settlement instruction, receipt, reconciliation-supporting atomic cross-chain swaps and interoperability with fiat rails, stablecoins, and CBDC platforms, using ISO 20022 mappings. Governance includes Universal Basic Time Income (UBTI), inflation/deflation controls, a TimeDAO, ESG/SDG impact scoring, and a selectively transparent audit interface using verifiable credentials and zero-knowledge proofs.

A human-readable naming and addressing layer (ReadName/BEIDOMAIN, e.g., TimeID) maps domain-style identifiers to BEIs/SBTs, wallets/vaults, TCH settlement endpoints, and regulator/audit endpoints to enable global scaling, white-label licensing, and cross-jurisdiction deployment.

### BRIEF DESCRIPTION OF THE DRAWINGS

FIG. 1—Identity and generation pipeline: BEI/SBT, behavior capture, time-proof creation, minting, ledger anchoring.

FIG. 2—Clearing sequence: order intake, matching, netting, settlement instruction, receipt, reconciliation.

FIG. 3—Anti-Sybil and risk controls: identity graphs, behavioral density, device/geo/biometric consistency, reputation thresholds.

FIG. 4—Dual-layer architecture: non-transferable SBT anchor versus transferable TMC; atomic binding and transfer restrictions.

FIG. 5—Coefficient model: skill tier, location factor, social-impact multiplier, and an optional Time-of-Time (ToT) dynamic time-window factor.

FIG. 6—Time Vault: reserves, lock periods, inheritance triggers, beneficiaries.

FIG. 7—Selective audit interface: verifiable-credential attestations and zero-knowledge summaries for regulators/audit nodes.

FIG. 8—TCH bridges: ISO 20022 message mapping, CBDC and fiat connectors, domain-addressed endpoints.

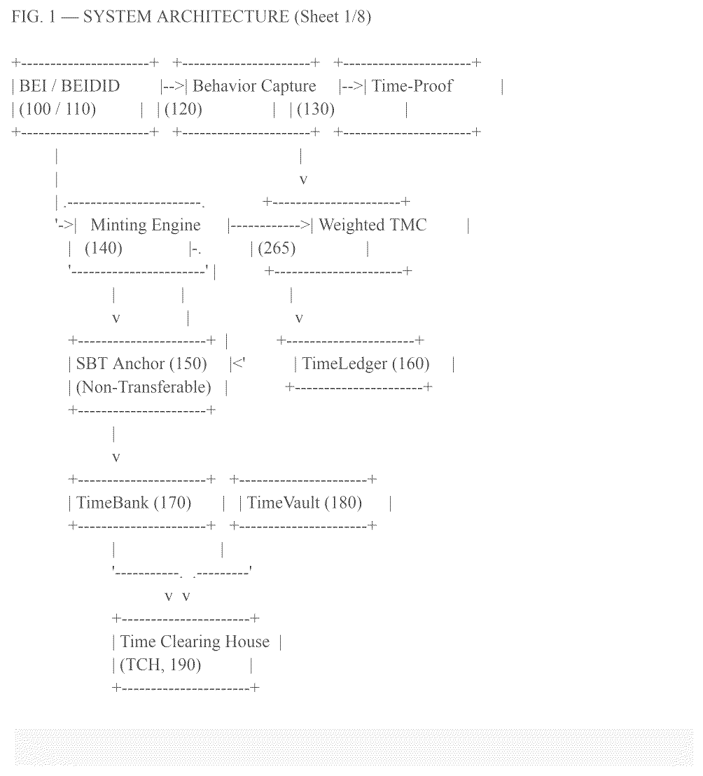

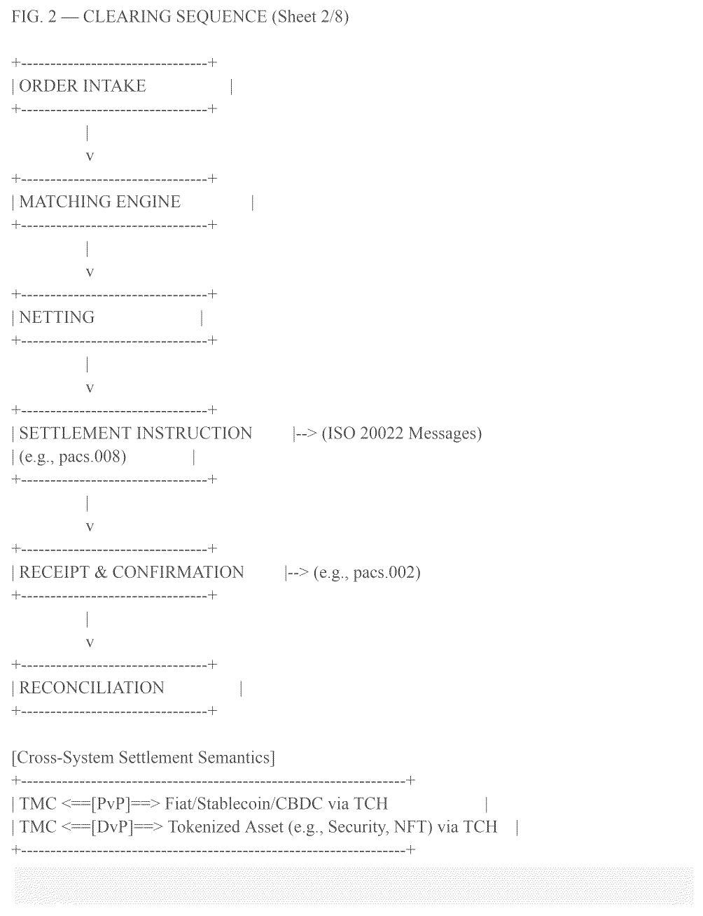

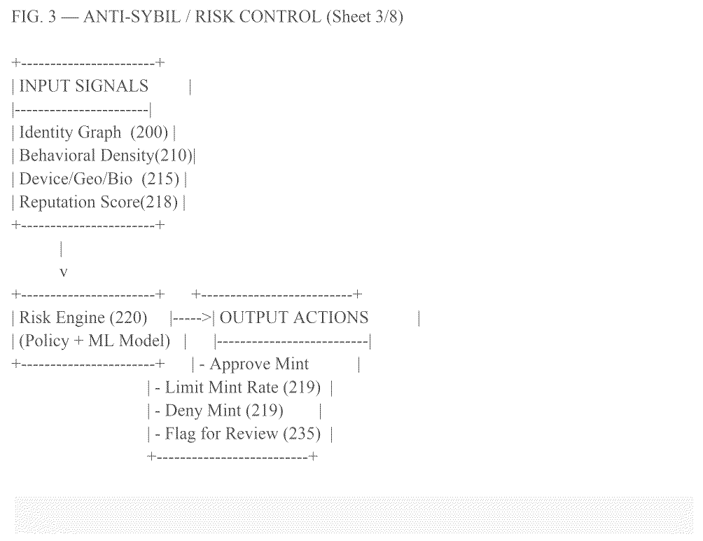

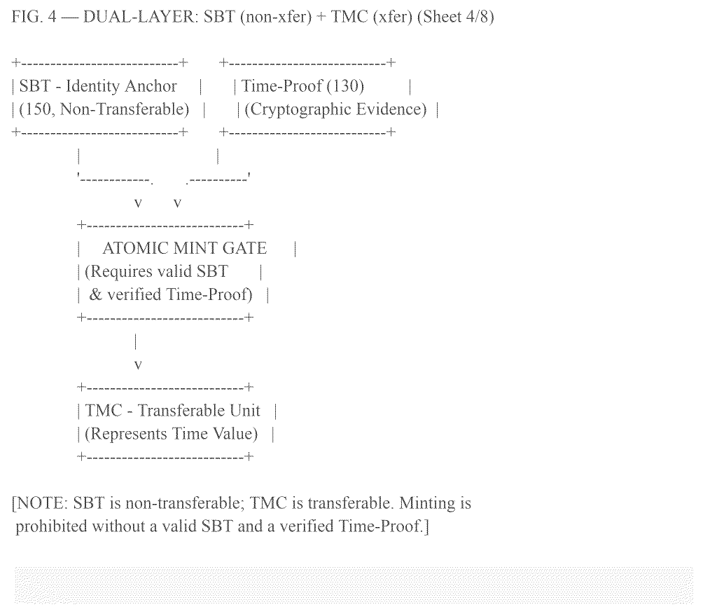

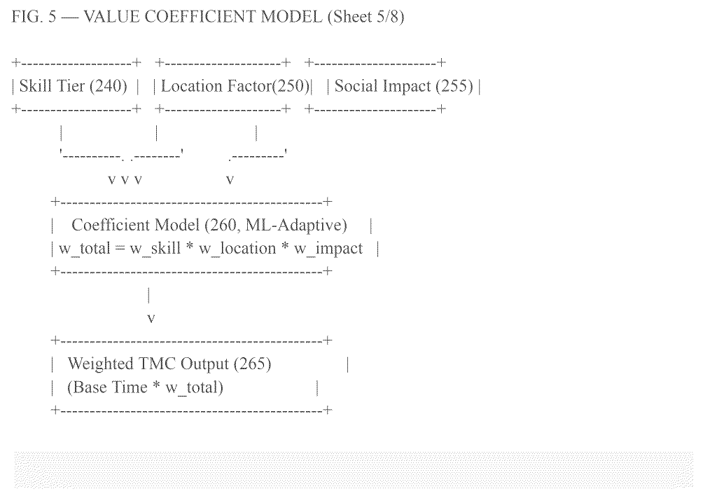

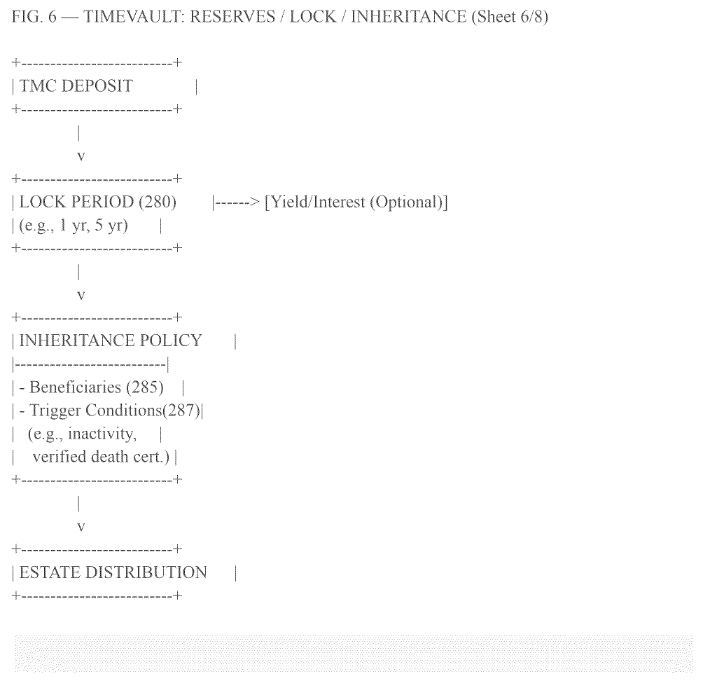

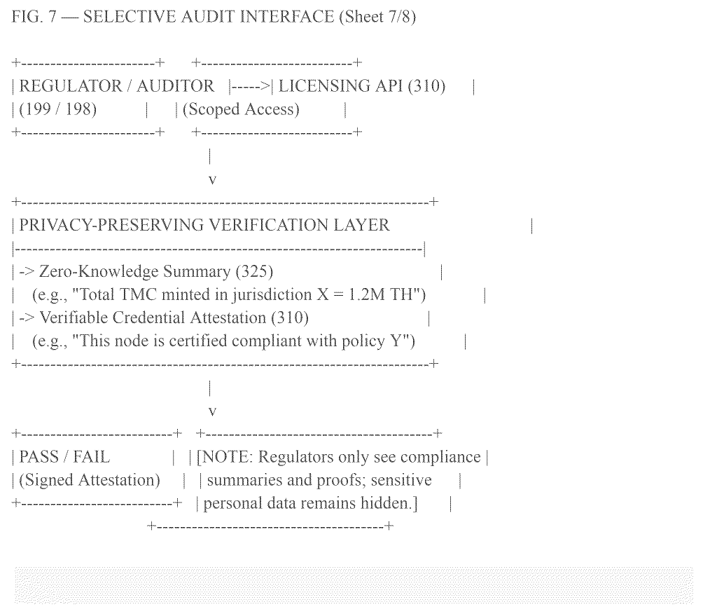

### DETAILED DESCRIPTION

### I. Identity and Generation Layer

BEI and SBT. A BEI (100) is established and verified by multi-factor evidence (government-grade credentials, biometrics, device attestations, reputation). A non-transferable SBT (150) is issued to the BEI and stores permissions, qualifications, and risk parameters.

Behavior Capture. Authorized sources (120) submit signed activity attestations including timestamps and context labels (for example, skill category, service class, SDG tag) consistent with lawful data handling.

Time-Proof. A time-proof (130) comprises an on-chain timestamp, digital signatures from a trusted issuer and the BEI, and a zero-knowledge statement showing policy compliance without exposing raw personal data. Proofs are replay-resistant via state-machine sequencing and nonce binding.

Minting. The mint engine (140) mints TMC only if BEI authentication, behavior attestation, and time-proof verification all succeed. The unit is denominated in time (minutes/hours/days/weeks) and weighted by a coefficient model (260) including skill tier (240), location parity (250), social-impact multiplier (255), and optionally a Time-of-Time (ToT) factor (265). The ToT factor is derived from ToT signal inputs (272) such as peak demand, emergency declarations, night/weekend/holiday periods, severe-weather events, service continuity and punctuality, and wait-time reduction. The ToT factor is policy-bounded and subject to fairness/privacy constraints; it does not alter the time nature of the unit, only valuation within permitted bounds.

Anchoring. Hashes of behavior records, time-proofs, and mint certificates are committed to the TimeLedger (160) for tamper evidence.

Anti-Fraud/Anti-Sybil. A risk engine (220) enforces mint caps and anomaly detection using identity graphs (200), behavioral density (210), device/geo/biometric consistency (215), and reputation thresholds (218). Flags (219) route to human-in-the-loop adjudication.

### II. Finance and Clearing Layer

TimeBank and TimeLedger. Multi-tier wallets (170) operate as nodes under Byzantine fault-tolerant consensus. The ledger records transfers, escrows, and metadata pointers to time-proofs.

Time Vault. Time Vault (180) contracts support reserves, savings, and inheritance with programmable lock periods (280), beneficiary lists (285), and estate triggers (287).

Time Clearing House (TCH). The TCH (190) defines interoperable messages and steps-order intake to matching to netting to settlement instruction to receipt to reconciliation-supporting atomic swaps, payment-versus-payment and delivery-versus-payment semantics, and mappings to ISO 20022 messages. Connectors interface to CBDC platforms and fiat rails (197). A market temperature controller adjusts throttles, fees, or settlement windows using volume, volatility, and sentiment indices and may consume ToT factor inputs. An on-chain insurance/compensation module prices risk using user credit grades and historical loss data.

### III. Governance and Compliance Layer

UBTI and Monetary Policy. UBTI allocates baseline TMC to active verified BEIs; monetary controls adjust issuance by reserves and velocity, with parameters published on-chain.

TimeDAO. Stakeholders vote on fees, policies, and upgrades. Voting power may reflect long-term contribution captured in SBT metadata.

Selective Audit Interface. Regulators (199) and clearing institutions access zero-knowledge summaries (320) and verifiable-credential attestations (310) via a scoped licensing API, enforcing data minimization and retention limits. A compliance proof (325) supports institutional audit without exposing individual-level data.

### IV. Naming and Addressing (ReadName/BEIDOMAIN)

A namespace registry assigns human-readable names (TimeID) to BEIs, organizations, and nodes. Names resolve to resource records: (i) SBT/BEI DID documents, (ii) wallet or vault endpoints, (iii) TCH settlement endpoints, and (iv) regulator or audit endpoints. Responses are signed and anchored with DNSSEC/DANE and may be mirrored to Certificate Transparency logs. DID/VC bindings provide verifiable control. The namespace supports white-label licensing, trust marks (“BEI-Verified,” “TCH-Ready”), and delegated sub-namespaces.

1. A computer-implemented method for generating a time-denominated digital currency unit (TMC), comprising: authenticating a unique Behavioral Economics Identity (BEI) of a user via a decentralized identity system; receiving a behavior record associated with the user from an authorized source; generating a cryptographic time-proof including an on-chain timestamp, digital signatures, and a zero-knowledge attestation that the behavior satisfies policy constraints; minting, only upon satisfaction of BEI authentication, behavior attestation, and time-proof verification, a transferable TMC weighted by a coefficient model; and recording a transfer or escrow of the TMC on a ledger with metadata pointers to the behavior record and the time-proof.

2. The method of claim 1, wherein the time-proof is produced by a state machine configured to prevent replay and double-mint events via epoch windows and nonce binding.

3. The method of claim 1, further comprising detecting Sybil or fraud conditions using identity graphs, behavioral density, device, geolocation, biometric consistency, and reputation thresholds to limit or deny minting.

4. The method of claim 1, wherein the coefficient model is updated by a machine-learning process constrained by fairness and privacy policies.

5. The method of claim 1, wherein the ledger stores hashes anchoring the behavior record and the time-proof for off-chain verification.

6. The method of claim 1, wherein the ToT factor is computed from at least one of peak demand, emergency status, night or weekend or holiday periods, severe-weather events, service continuity or punctuality metrics, and wait-time reduction, the ToT factor being policy-bounded within a predetermined range.

7. A system for interoperable clearing and settlement of TMC, comprising: a multi-tier TimeBank wallet network operating under a Byzantine fault-tolerant consensus; a TimeLedger storing TMC transfers and metadata pointers; a Time Vault smart contract controlling reserves, lock periods, inheritance, and beneficiary distributions; a naming and resolution subsystem mapping human-readable identifiers to BEIs/SBTs, wallets, vaults, and settlement or audit endpoints; and a Time Clearing House (TCH) defining message formats and steps including order intake, matching, netting, settlement instruction, receipt, and reconciliation.

8. The system of claim 7, wherein the TCH supports atomic swaps and payment-versus-payment or delivery-versus-payment semantics across chains.

9. The system of claim 7, wherein the TCH maps messages to ISO 20022 and interfaces with central bank digital currency platforms and fiat rails, and exposes domain-addressed settlement endpoints secured by DNSSEC/DANE and verifiable-credential proofs.

10. The system of claim 7, further comprising an on-chain insurance and compensation module that prices risk according to user credit grades and historical volatility.

11. The system of claim 7, further comprising a market temperature controller that adjusts trading limits, fees, or settlement windows based on volume, volatility, and sentiment indices and, in some embodiments, on ToT factor inputs.

12. The system of claim 7, wherein the Time Vault triggers estate distribution upon occurrence of pre-defined conditions including a verified death certificate, inactivity timeouts, or a guardianship multi-signature.

13. The system of claim 7, wherein settlement includes conversion between TMC and at least one of fiat currency, stablecoins, and IMF Special Drawing Rights.

14. A governance and licensing mechanism for TMC, comprising: an algorithm for Universal Basic Time Income (UBTI) allocation to verified BEIs; an inflation or deflation control protocol adjusting issuance based on global TMC reserves and velocity; a code generator for international denomination and settlement codes including BEITMC and BEISDR; a namespace registry assigning and resolving human-readable names to BEIs or SBTs, wallets, vaults, clearing endpoints, and regulator or audit endpoints; and a TimeDAO that establishes fee schedules and cross-border authorization regimes.

15. The mechanism of claim 14, wherein UBTI allocations adjust according to contribution indices and sustainable-development indicators.

16. The mechanism of claim 14, wherein the inflation or deflation protocol supports daily, monthly, and yearly tuning cycles with on-chain transparency of parameters.

17. The mechanism of claim 14, wherein the international codes comply with currency-code standards and are published into the namespace registry to enable DNS or DID-based discovery for settlement and reporting.

18. The mechanism of claim 14, wherein the TimeDAO governs fee schedules and cross-border authorization regimes including per-node, per-volume, and per-term pricing.

19. The mechanism of claim 14, wherein the licensing API enforces selective audit through data-minimized, scope-limited access, zero-knowledge summaries, and verifiable-credential attestations.

20. The mechanism of claim 14, wherein ESG or SDG impact scores are computed from on-chain transactions and external environmental, social, and governance data to generate a time-currency credit grade.
